(19) United States
(12) Patent Application Publication
(10) Pub. No.: US 2026/0247098 A1
(43) Pub. Date: Aug. 20, 2026

(54) GENERATING SPATIAL METADATA BY PERFORMERS

(71) Applicant: DOLBY LABORATORIES LICENSING CORPORATION, San Francisco, CA (US)

(72) Inventors: Kenneth Nicholas Schindler, Pleasant Hill, CA (US); Joshua B. Lando, Mill Valley, CA (US); Eric Whelan Yeargan, Los Angeles, CA (US); Stewart Murrie, San Francisco, CA (US); Stephen Spencer Hooks, San Mateo, CA (US); Sophia Genung Poirier, San Francisco, CA (US); Joel Robert Kustka, San Francisco, CA (US); David Matthew Cooper, Carlton New South Wales (AU)

(73) Assignee: DOLBY LABORATORIES LICENSING CORPORATION, San Francisco, CA (US)

(21) Appl. No.: 19/161,092

(22) PCT Filed: Feb. 29, 2024
(86) PCT No.: PCT/US2024/017905

§ 371 Date: Aug. 29, 2025

Related U.S. Application Data
(60) Provisional application No. 63/449,550, filed on Mar. 2, 2023.

(30) Foreign Application Priority Data
Apr. 13, 2023 (EP) 23167681.8

(51) Int. Cl. H04S 7/00; G10H 1/00; G10H 5/00

(52) U.S. Cl. CPC H04S 7/307; G10H 1/0008; G10H 1/0066; G10H 5/002; G10H 2240/075; G10H 2240/311; G10H 2250/025; H04S 2400/11; H04S 2400/15

(57) ABSTRACT

Methods, systems, and computer program products for generating spatial metadata by performers are disclosed. The method includes receiving one or more audio essences and spatial metadata corresponding to one or more audio essences generated by at least one performer in an audio performance. The one or more audio essences and the spatial metadata are generated by the at least one performer simultaneously, and the spatial metadata includes spatial coordinates in a rendering coordinate space. The spatial coordinates are associated with the one or more audio essences and determined by the at least one performer. The method further includes spatially rendering the one or more audio essences to one or more immersive sound mixes according to the spatial metadata, wherein the one or more immersive sound mixes are provided to at least one of a local live audience, the at least one performer, a mixing engineer, or a remote live audience.

### CROSS-REFERENCE TO RELATED APPLICATIONS

This application claims priority from U.S. Provisional Application No. 63/449,550, filed 2 Mar. 2023 and European Patent Application No. EP 23167681.8 filed on 13 Apr. 2023, each of which is incorporated by reference herein in its entirety.

### TECHNICAL FIELD

This disclosure relates generally to rendering audio essences using generated metadata.

### BACKGROUND

Generally, a front-of-house mixing engineer is responsible for controlling the volume, balance, and equalization (EQ) of a live performance from a mixing console. Music performers have no direct control over the rendering (e.g., panning or controlling spatial location, etc.) of their performances.

As early as the 1880s, there were examples of live performances being broadcast for a remote audience. Earlier unamplified performances made use of telephony infrastructure and allowed a listener at home to experience live opera, theater music, and classical music. These early performances were unamplified and thus did not involve a front-of-house mixing engineer. The technology for live broadcasts progressed to radio and then television, which required amplified music. The advent of amplified music involved a front-of-house mixing engineer, whose work was also used as broadcast material. More recent live broadcasts can be done over internet protocol networks, by means of CODEC technologies such as Dolby Digital Plus.

In the mid-twentieth century, live musical performances increased in popularity with the proliferation of jazz and rock music. As the size of audiences increased, the need for amplifying sound of the instrumentalists and vocalists became paramount so they could be heard. Initially, the primary concern was generating adequate sound-pressure level (SPL), followed shortly by sound quality to deliver the same experience to all sections of the venue. Accurate spatial localization of the performers and their instruments was not of great concern, and the audience could tell broadly where on stage the sound was emanating from. By the late 1960s, the triple-amplification system for live sound reinforcement emerged including the backline of amplified instruments on stage, separate speaker monitors for the musicians, and speaker towers for Public Address (PA) to the audience with the focus on creating a “wall of sound” to mitigate inverse square loss and improve phase coherence of the pressure wavefront propagating to the entire audience. Some equipment used for sound reinforcement was stereo while other gear passed only monaural channels. As technology advanced, concerts were standardized to be stereo presentations. In the 1970s, there was a brief period of experimentation with quadraphonic surround systems. PA systems evolved into more sophisticated Front-of-House (FOH) loudspeaker line arrays capable of generating significantly higher SPL, wider frequency response, and lower distortion, as well as signal processing effects to improve phase coherence and equalization. For nearly 50 years, sound reinforcement mixes have remained largely stereo even with further advances in audio spatial localization technology in adjacent markets (e.g., various surround sound formats in the cinema).

However, auditory spatial localization was controlled primarily by the front-of-house and monitor mix engineers running their respective consoles, although some electrical/electronic instruments and effects (e.g., stereo keyboards, effects units with stereo sends and returns, stereo guitars, etc.) have allowed for direct control of stereo imaging on stage or via direct outputs to the FOH and monitor mix consoles.

With the advent of immersive audio formats, which include distinct audio essence and metadata, much greater control of spatial localization within the rendering coordinate space can be achieved. This technology has matured in the cinema and has started to spread into the live sound and electronic music spaces. However, the spatial metadata governing audio rendering has still been controlled by the mixing engineers, instead of directly by the live performers.

### SUMMARY

Systems, program products, and methods for rendering audio essences using spatial metadata generated and/or modified by performers are disclosed.

The features described in this specification can achieve one or more advantages over conventional audio technology. The techniques of this disclosure enable performers to have direct control of their respective audio essences in real-time. The techniques of this disclosure enable one or more performers to have complete or partial control over rendering of their own audio essences (e.g., vocal music, instrumental music) during a live performance, instead of solely relying on a mixing engineer (e.g., front-of-house mixer). The techniques of this disclosure can further provide collaborative modification of spatial metadata by a plurality of performers and/or mixing engineers and allow for monitoring of the rendered immersive audio by one or more performers.

In one aspect, the features improve upon conventional manual audio processing technology by an innovative method including: receiving, by a processor, one or more audio essences and spatial metadata corresponding to the one or more audio essences generated by at least one performer in an audio performance, wherein the one or more audio essences and the spatial metadata are generated by the at least one performer simultaneously, and the spatial metadata includes spatial coordinates in a rendering coordinate space, wherein the spatial coordinates are associated with the one or more audio essences and determined by the at least one performer; and spatially rendering, by the processor, the one or more audio essences to one or more immersive sound mixes according to the spatial metadata, wherein the one or more immersive sound mixes are provided to at least one of a local live audience, the at least one performer, a mixing engineer, or a remote live audience.

Other aspects include apparatuses, systems, and computer programs for performing the actions of the aforementioned method.

The innovative method can include other optional features. For example, in some implementations, wherein receiving the one or more audio essences and the spatial metadata corresponding to the one or more audio essences generated by the at least one performer further comprises: receiving motion data from an inertial measurement unit associated with a microphone used by the at least one performer, a musical instrument played by the at least one performer, or the at least one performer; and converting the motion data in a control coordinate space of the inertial measurement unit to the spatial metadata in the rendering coordinate space using one or more mapping functions.

In some implementations, wherein receiving the one or more audio essences and the spatial metadata corresponding to the one or more audio essences generated by the at least one performer further comprises: receiving motion data from a multi-axis pedal used by the at least one performer, wherein the motion data includes changes in azimuth or elevation of the multi-axis pedal; and converting the motion data in a control coordinate space of the multi-axis pedal to the spatial metadata in the rendering coordinate space using one or more mapping functions.

In some implementations, wherein receiving the one or more audio essences and the spatial metadata corresponding to the one or more audio essences generated by the at least one performer further comprises: receiving motion data from a joystick used by the at least one performer; and converting the motion data in a control coordinate space of the joystick to the spatial metadata in the rendering coordinate space using one or more mapping functions.

In some implementations, wherein receiving the one or more audio essences and the spatial metadata corresponding to the one or more audio essences generated by the at least one performer further comprises: receiving motion data from a gesture tracking device or a radio frequency transmitter/receiver proximate to the at least one performer; and converting the motion data in a control coordinate space of the gesture tracking device or a radio frequency transmitter/receiver to the spatial metadata in the rendering coordinate space using one or more mapping functions.

In some implementations, wherein receiving the one or more audio essences and the spatial metadata corresponding to the one or more audio essences generated by the at least one performer further comprises: receiving operations on an electronic musical instrument from the at least one performer, wherein the electronic musical instrument is a synthesizer or a step sequencer; and converting the operations in a control coordinate space of the electronic musical instrument to the spatial metadata in the rendering coordinate space using one or more mapping functions.

In some implementations, wherein the synthesizer includes one or more low frequency oscillators, and the operations on the electronic musical instrument include controlling the one or more low frequency oscillators to generate the spatial metadata, wherein the one or more low frequency oscillators are configured to generate a plurality of layers of sounds for the one or more audio essences generated by the at least one performer.

In some implementations, wherein the one or more audio essences include an original audio essence, an audio essence having sound effects, or a combination of the original audio essence and the audio essence having sound effects, wherein the spatial metadata generated by controlling the one or more low frequency oscillators are used to render the original audio essence, the audio essence having sound effects, or the combination of the original audio essence and the audio essence having sound effects.

In some implementations, wherein the synthesizer includes an envelope generator, and the spatial metadata in the rendering coordinate space is generated by operating the synthesizer to control the envelope generator.

In some implementations, wherein the synthesizer includes a random voltage generator, and the spatial metadata in the rendering coordinate space is generated by operating the synthesizer to control the random voltage generator.

In some implementations, wherein receiving the one or more audio essences and the spatial metadata corresponding to the one or more audio essences generated by the at least one performer further comprises: receiving operations on a Musical Instrument Digital Interface (MIDI) Polyphonic Expression controller played by the at least one performer, wherein the MIDI Polyphonic Expression controller includes a touch-sensitive screen or a control user surface, each point of the touch-sensitive screen or the control user surface corresponds to a spatial coordinate in the spatial metadata, wherein the operations include one or more hand gestures operated on the touch-sensitive screen or the control user surface.

In some implementations, the method further comprises receiving modified spatial metadata, wherein the spatial metadata is modified by the at least one performer, at least one additional performer, a mixing engineer, or an algorithm based on an attribute of the one or more audio essences, wherein the modified spatial metadata is configured for translating, scaling, rotating, or temporally filtering the spatial metadata.

In some implementations, wherein the spatial metadata is modified based on an attribute of the one or more audio essences.

In some implementations, wherein the spatial coordinates are located within a particular zone of an overall spatial presentation.

In some implementations, wherein receiving the modified spatial metadata further comprises: dividing the one or more audio essences into a plurality of frequency bands; and modifying the spatial metadata of an audio essence in a particular frequency band among the plurality of frequency bands.

In some implementations, the method further comprises generating a visualization of the spatial metadata for the at least one performer.

In some implementations, wherein spatially rendering the one or more audio essences comprises providing the one or more audio essences to a speaker array for an audience, a binaural audio render for the at least one performer, a broadcasting device, or a recording device.

In some implementations, wherein spatially rendering the one or more audio essences comprises: dividing the one or more audio essences into a plurality of groups; rendering each of the plurality of groups separately to generate a plurality of spatial sub-mixes corresponding to the plurality of groups; and modifying the spatial metadata of a particular spatial sub-mix among the plurality of spatial sub-mixes.

According to another innovative aspect of the present disclosure, a system is provided, and including: at least one processor; and a memory storing instructions that, when executed by the at least one processor, cause the at least one processor to perform operations according to the above-mentioned method.

According to another innovative aspect of the present disclosure, a non-transitory, computer-readable medium is provided and storing instructions that, when executed by at least one processor, cause the at least one processor to perform operations according to the above-mentioned method.

The details of one or more implementations of the disclosed subject matter are set forth in the accompanying drawings and the description below. Other features, aspects, and advantages of the disclosed subject matter will become apparent from the description, the drawings, and the claims.

### BRIEF DESCRIPTION OF THE DRAWINGS

FIG. 1 is a diagram illustrating an example architecture of a metadata generating and rendering system, according to an embodiment.

FIG. 2 is a diagram illustrating an example mapping relationship between an inertial measurement unit (IMU) and a three-dimensional (3D) rendering coordinate space, according to an embodiment.

FIGS. 3A-3C are diagrams illustrating an example mapping relationship between IMU and spatial coordinates, according to an embodiment.

FIG. 3D is a diagram illustrating an example mapping function between a control coordinate space of a particular controller and a rendering coordinate space, according to an embodiment.

FIG. 4 is a diagram illustrating an example mapping relationship between a foot pedal and a 3D rendering coordinate space, according to an embodiment.

FIG. 5 is a flow chart illustrating an example process of generating and rendering spatial metadata, according to an embodiment.

FIG. 6 is a flow chart illustrating another example process of generating and rendering spatial metadata, according to an embodiment.

FIG. 7 is a block diagram illustrating an example system implementing the features and operations described in reference to FIGS. 1-6.

Like reference symbols in the various drawings indicate like elements.

### DETAILED DESCRIPTION

Systems, program products, and methods for rendering audio essences using spatial metadata generated and/or modified by performers are disclosed. The techniques of this disclosure can provide performers with direct control of rendering live immersive audio essences. The techniques of this disclosure include a plurality of embodiments for real-time generation and/or modification of immersive audio metadata (e.g., spatial metadata) by one or more performers in live performances or studio recordings. In some embodiments, the spatial metadata is generated via an inertial measurement unit (IMU) attached to a performer, a musical instrument played by a performer, or a microphone used by a performer. In an example, the IMU is integrated into the musical instrument played by a performer and the microphone used by a performer. In some embodiments, the spatial metadata is generated via a multi-axis pedal (e.g., foot pedal). In some embodiments, the spatial metadata is generated via a gesture tracking device, a radio frequency (RF) transmitter/receiver (e.g., near-field communication (NFC)) near a performer. In some embodiments, the spatial metadata is generated via a position tracking device, such as a light detection and ranging (LiDAR) sensor, a global positioning system (GPS), etc. In an example, the gesture tracking device, the RF transmitter/receiver, or the position tracking device can be attached to or close to the musical instrument played by a performer. In an example, the gesture tracking device, the RF transmitter/receiver, or the position tracking device can be integrated into the musical instrument played by a performer. In some embodiments, the spatial metadata is generated via an electronic musical instrument, such as a synthesizer or a step sequencer. In some embodiments, the spatial metadata is generated via a control user interface or a touch-sensitive screen, e.g., Musical Instrument Digital Interface (MIDI) Polyphonic Expression controller, etc. In an example, the control user interface or the touch-sensitive screen can be integrated into an electronic musical instrument (e.g., a synthesizer or a step sequencer). The spatial metadata can be generated by one or more performers and modified by one or more performers or a mixing engineer. In some embodiments, the spatial metadata includes spatial coordinates, e.g., X, Y, and Z coordinates in a three-dimensional (3D) rendering coordinate space.

Additionally, the techniques of this disclosure provide collaborative modification of spatial metadata by a plurality of performers and/or mixing engineers and monitoring of the rendered immersive audio by one or more performers. The techniques of this disclosure enable one or more performers to have complete or partial control over rendering of their own audio essences (e.g., vocal music, instrumental music) during a live performance, instead of solely relying on a mixing engineer (e.g., front-of-house mixer).

The term “audio essence” may refer to an audio signal or the sound of an audio source. The term “metadata” may refer to audio attributes that affect the spatial rendering of audio essences by an immersive audio renderer, e.g., spatial metadata or spatial coordinates of audio essences, audio level, audio size, distance (distance between audio essences), zone mask (an audio zone to be ignored), snap (relocation of an audio essence to minimize the audible result of panning), and priority (priority of audio essences), etc. The term “spatial metadata” may refer to spatial coordinates of audio essences. The term “rendering coordinate space” may refer to a coordinate space of a rendering system (e.g., headphone 126, speaker array 128, recording device 130, broadcasting device 132, etc.), in which the sounds are being rendered for the audience to perceive. The term “control coordinate space” may refer to a coordinate space of a particular controller, such as MIDI control user surface 108, IMU 110, algorithm 112, pedal 114, synthesizer 116, etc. Each controller has its own control coordinate space.

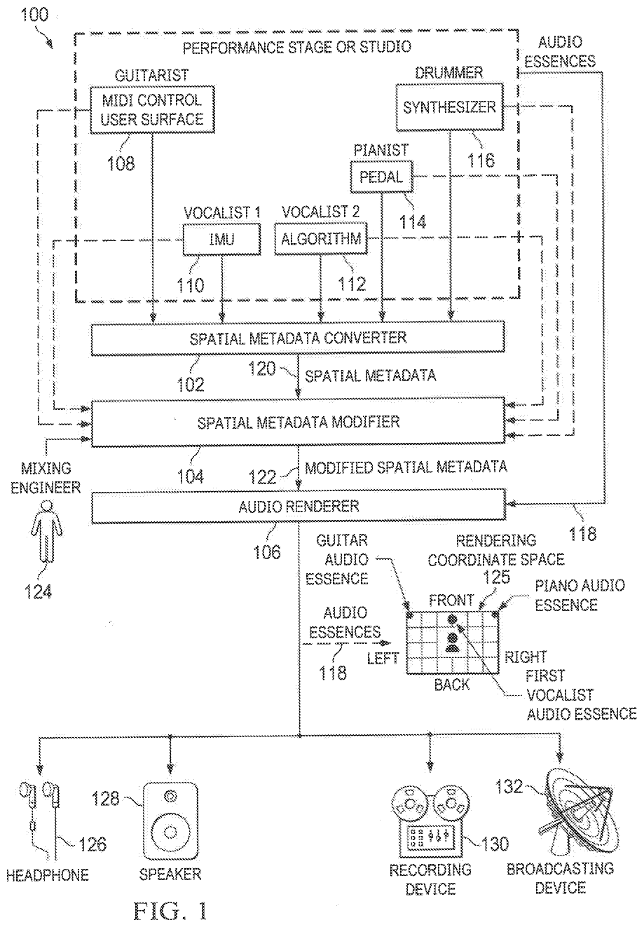

FIG. 1 is a diagram illustrating an example architecture of metadata generating and rendering system 100, according to an embodiment. The metadata generating and rendering system 100 can be applied in a live performance or a studio. The live performance is any audio performance where audio content (e.g., speech, vocal music or instrumental music) and optionally, video content, are produced. In an example, the live performance can be a live concert in which one or more musical instruments and/or one or more vocalists perform. One or more sound sources can be present at the live performance or a studio. Each sound source can be an instrument, a vocalist, a loudspeaker, or any item that produces sound.

As shown in FIG. 1, the metadata generating and rendering system 100 includes spatial metadata converter 102, configured to convert motions (e.g., movement on a performance stage, foot motion on a pedal) or operations (e.g., operations on electronic musical instruments, operations on a touch-sensitive user interface, operations on an algorithm, etc.) of performers to spatial metadata; spatial metadata modifier 104, configured to modify the converted spatial metadata (performer-generated spatial metadata); and audio renderer 106, configured to render audio essences using the modified spatial metadata.

As some examples, a guitarist is operating on a control user surface 108 (e.g., a MIDI control user surface or a MIDI controller 108) while the guitarist is playing guitar. The motion of the first vocalist (lead vocalist) is detected by IMU 110 while the first vocalist is singing. The second vocalist is operating on an algorithm 112 on a display while the second vocalist is singing. A pianist is operating a pedal 114 with his/her foot while the pianist is playing piano. A drummer is operating a synthesizer 116 while the drummer is playing a drum. These performers are generating spatial metadata by physical motions or operating different devices, while generating audio essences 118 (audio data of sound sources).

In some embodiments, audio essences and spatial metadata are generated simultaneously, but can be sent separately to the audio renderer 106, as long as audio essences 118 and spatial metadata remain synchronized. For example, in a Dolby Atmos® system, spatial metadata is transferred from the digital audio workstation to a renderer via a network link, while the audio essences are transferred by a virtual soundcard, Dolby Audio Bridge, or a real soundcard using a low-latency high-bandwidth digital audio network (e.g., Ethernet (Dante), multi-channel audio digital interface (MADI), Audio Engineering Society (AES) 67, AES 10, etc.). These two paths (audio essences and spatial metadata) are separate, with each path leading to the audio renderer.

The operations on the MIDI control user surface 108, physical motion (represented by yaw, pitch, roll) detected by the IMU 110, operations on the algorithm 112, physical motion (represented by azimuth, elevation) on the pedal 114, and operations on the synthesizer 116 can be provided to the spatial metadata converter 102 and converted to spatial metadata by the spatial metadata converter 102.

The techniques of this disclosure allow performers to generate their own spatial metadata. The performers can directly control generation of spatial metadata during an active performance which is presented in an immersive audio context. The performers can generate spatial metadata using their musical instruments, such as an electronic or electric guitar, a keyboard instrument, a handheld microphone, or an acoustic instrument.

In some embodiments, the techniques of this disclosure can be used to control spatial metadata corresponding to multiple audio channels produced by a performer. For example, a synthesizer may output stereo or even multi-channel spatial audio essences. The performer can modify the spatial metadata pertaining to each of the audio channels individually or in combination.

In some embodiments, an acoustic source is captured with an ambisonic microphone (e.g., a first-order-ambisonic (FoA) or a higher-order-ambisonic (HoA) microphone). The performer-generated spatial metadata can be used to rotate, translate, or scale the ambisonic audio essences for the rendering of the acoustic source by an audio renderer 106.

In some embodiments, the IMU 110, with three, six, or nine degrees of freedom, can detect physical motion of a performer (e.g., the first vocalist). In an example, the IMU 110 can be attached to a handheld microphone and detect physical motion of the first vocalist. In an example, the IMU can be attached to a musical instrument (e.g., an electronic guitar, a bell of a saxophone, etc.) and detect physical motion of a performer playing the musical instrument. In an example, the IMU can be attached to the first vocalist and detect the physical motion of the first vocalist. The IMU can measure the position, velocity, and acceleration data of the performer. The measured IMU data can be converted to real-time spatial metadata (e.g., spatial coordinates that can be interpreted by the audio renderer 106) by the spatial metadata converter 102. The spatial metadata converter 102 can use one or more mapping functions to perform the conversion. For example, a linear mapping function (e.g., a rotation matrix) can be used to convert yaw, pitch, and roll components to X, Y, and Z coordinates (spatial coordinates). The rotation matrix can be multiplied to the original audio essence X, Y, and Z position (represented by yaw, pitch, and roll components) respectively to generate the resulting audio essence X, Y, and Z position.

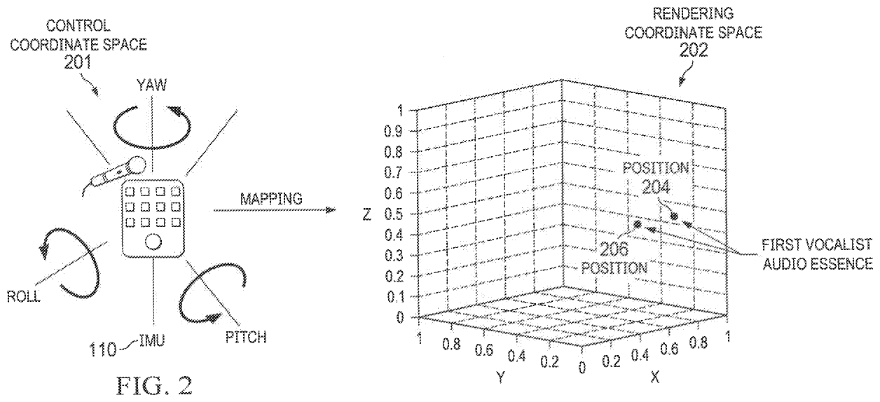

FIG. 2 is a diagram illustrating a mapping relationship between an IMU and a 3D rendering coordinate space, according to an embodiment. The rendering coordinate space refers to where the sounds are being created for the audience to perceive. For example, the rendering coordinate space can be a virtual sound stage (VSS). The VSS is an audio plug-in, which can show positions of musical instruments on a virtual stage corresponding to the physical performance stage or the studio. As shown in FIG. 2, IMU 110 is attached to a microphone held by the first vocalist. The IMU 110 detects motion (represented by yaw, pitch, and roll) of the first vocalist when he/she is moving on the performance stage or in the studio. The motion is converted to 3D spatial coordinates on rendering coordinate space 202 (rendering coordinate space/system). The motion data (yaw, pitch, and roll components) in a control coordinate space 201 of the IMU 110 is mapped to rendering coordinate space 202. For example, the audio essence of the first vocalist can change the position on rendering coordinate space 202 from the position 204 to the position 206 in response to motion of the first vocalist on the physical performance stage or in the studio.

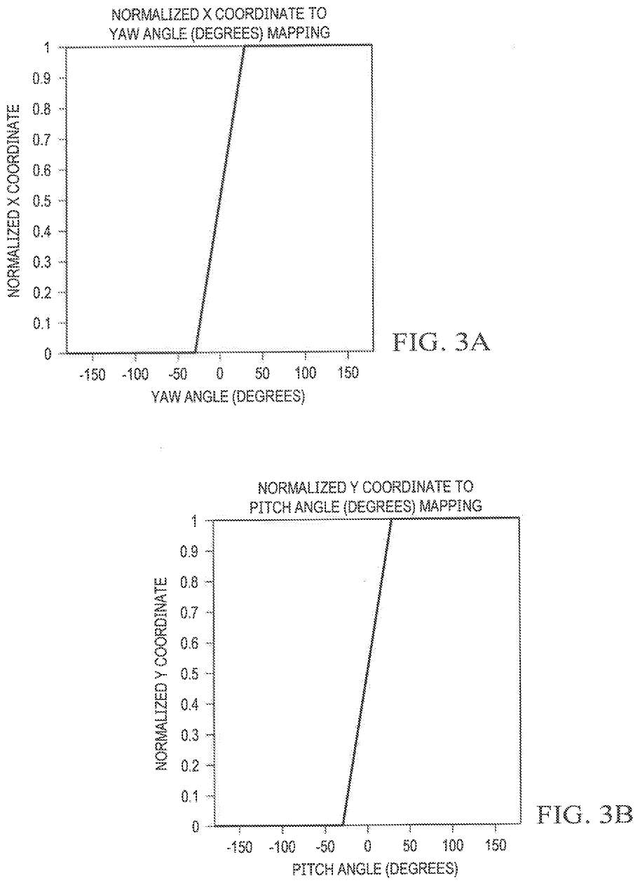

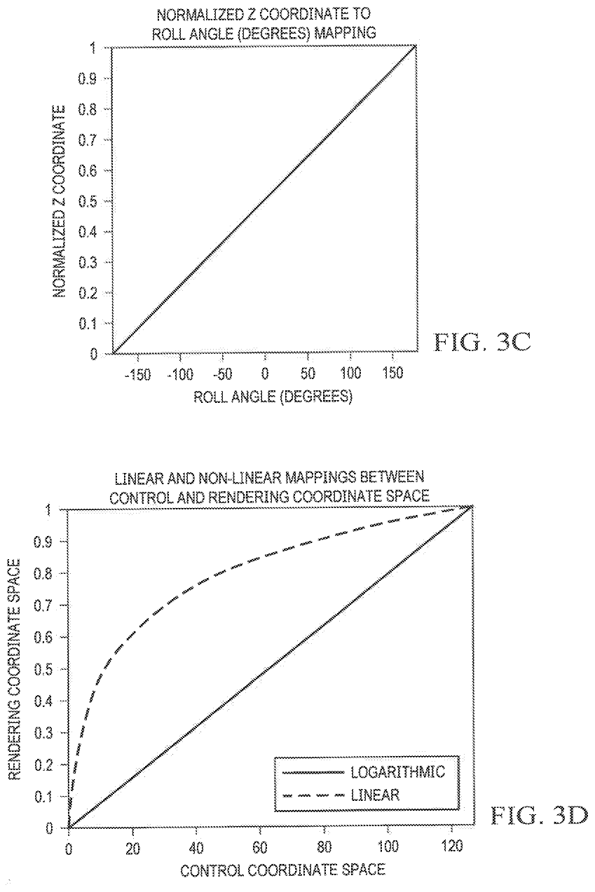

FIGS. 3A-3C are diagrams illustrating a mapping relationship between IMU and spatial coordinates, according to an embodiment. As shown in FIGS. 3A-3C, yaw angle, pitch angle, and roll angle are converted to X, Y, and Z coordinates on rendering coordinate space through a linear mapping function.

In some embodiments, a positioning tracking device, such as a radio frequency (RF) transmitter/receiver (e.g., a near-field communication (NFC) device), a global positioning system (GPS), etc. can be used to track a performer's position on stage which can be converted to 3D spatial coordinates in rendering coordinate space. For example, the performer's physical position on the stage can be directly mapped to the entirety of the rendering coordinate space or to a sub-region within the rendering coordinate space, such that motion on the stage would result in rendered motion constrained within that sub-region. In some embodiments, a gesture tracking device such as a tactile pressure sensor or a pair of “sensor gloves” can be used to track performer's hand gestures on stage that are converted to 3D spatial coordinates in rendering coordinate space. In some embodiments, an image camera, combined with image recognition software, can be used to track the performer's position or hand gestures on stage.

FIG. 3D is a diagram illustrating an example mapping function between a control coordinate space of a particular controller and a rendering coordinate space, according to an embodiment. The mapping function can be a non-linear mapping function (e.g., logarithmic function) or a linear mapping function. FIG. 3D applies to any controller that a performer uses for generating spatial metadata corresponding to his/her audio essence (e.g., vocal sound, musical instrument sound, etc.). For example, FIG. 3D applies to a particular controller, such as MIDI control user surface 108, IMU 110, algorithm 112, pedal 114, or synthesizer 116, etc.

In some embodiments, a performer uses a multi-axis pedal (e.g., 2-axis expression pedal connected to an analog-to-digital (A/D) converter) while the performer is playing the musical instrument (e.g., guitar, bass, violin, piano, etc.) and/or singing. For example, as shown in FIG. 1, the pianist operates his/her foot on the pedal 114. The physical motion of the multi-axis pedal can be converted to real-time spatial metadata by the spatial metadata converter 102. The spatial metadata converter 102 uses one or more mapping functions (e.g., a linear mapping function) to convert foot motion on the pedal to spatial metadata. For example, an audio essence's X position within a range [−1, 1] can be directly calculated from the pedal position, wherein a fully lowered pedal yields an X value of −1 and a fully raised pedal yields an X value of 1. In some embodiments, the motion data includes changes in azimuth and/or elevation of the multi-axis pedal. The azimuth and/or elevation data can be converted to real-time spatial metadata.

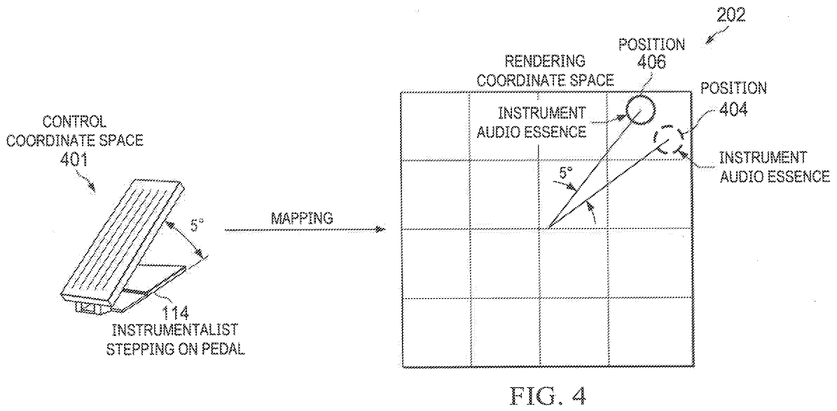

FIG. 4 is a diagram illustrating a mapping relationship between a 2-axis pedal and a rendering coordinate space, according to an embodiment. An instrumentalist (e.g., pianist) is stepping on the pedal 114 when the instrumentalist is playing a musical instrument (e.g., piano). For example, the azimuth of the pedal 114 is 5°, which is mapped to the 3D rendering coordinate space 202, e.g., from the position 404 to the position 406 in response to the motion of the pedal 114 on the physical performance stage or in the studio. The motion data (azimuth, elevation) in a control coordinate space 401 of the pedal 114 is mapped to rendering coordinate space 202.

In some embodiments, a performer uses a joystick while the performer is playing the musical instrument (e.g., guitar, bass, violin, etc.) and/or singing. In an example, the performer periodically manipulates a joystick briefly while playing the musical instrument. The physical motion of the joystick can be converted to real-time spatial metadata, by the spatial metadata converter 102, using one or more mapping functions (e.g., a linear mapping function). A two-dimensional, for example, joystick outputs two values depending on the position of the joystick. The first value of these two values can be mapped to the X coordinate of the rendering coordinate space, and the second value can be mapped to the Y coordinate of the rendering coordinate space. The proportionality of these values to their mapped coordinates may be linear mapping, or non-linear mapping. The non-linear mapping provides more resolution over a particular part of the X coordinate range. For example it may be artistically important to have more resolution in the middle of the X coordinate range The non-linear mapping can apply to any controller. Any desired non-linear function can be used to achieve more resolution in control coordinate space where needed.

Referring back to FIG. 1, in some embodiments, the performer can generate spatial metadata using an electronic musical instrument, such as a synthesizer or a step sequencer. The operations on the electronic musical instrument can be converted to spatial metadata, by the spatial metadata converter 102, using one or more mapping functions (e.g., a linear mapping function). The operations can be, e.g., pressing keys on a keyboard integrated into the synthesizer, or setting steps on the step sequencer. For example, at each step a “step sequencer” outputs a value depending on how the performer sets the controls for that step. This value, for example, can then be mapped onto the Z coordinate (height coordinate) of the rendering coordinate space. The proportionality of the value to the Z coordinate may be a linear mapping, or non-linear mapping. The non-linear mapping could then provide more resolution over a particular part of the height range that may be of particular artistic interest and therefore need the more fine-grained control offered by increased resolution.

In some embodiments, the synthesizer 116 includes one or more low-frequency oscillators (LFO). The spatial metadata is generated to control audio essences using oscillating patterns to produce layers of sounds. The LFOs are configured to generate a plurality of layers of sounds for the audio essences generated by a performer. The spatial metadata can include spatial coordinates to match the oscillation of the LFOs. For example, the spatial metadata includes changing from first coordinates to second coordinates back and forth multiple times to match the oscillation of the LFOs.

In some embodiments, audio essences 118 include original audio essences, audio essences having sound effects (referred to as “effect essences”), or a combination of the original audio essences and the effect essences. The spatial metadata generated by controlling the LFOs can be used to render the original audio essences, effect essences, or the combination of the original audio essences and the effect essences. The original audio essences and the effect essences can be synchronized with the LFOs.

In some embodiments, the synthesizer 116 includes an envelope generator, and the spatial metadata is generated by operating the synthesizer to control the envelope generator. In some embodiments, the synthesizer 116 includes a random voltage generator, and the spatial metadata is generated by operating the synthesizer 116 to control the random voltage generator. In some embodiments, the synthesizer 116 includes an integrated keyboard. In some embodiments, the synthesizer 116 does not include a keyboard (e.g., a modular synthesizer).

In some embodiments, the step sequencer can be used to control the height of the audio essences (e.g., audio level), so that the height of the audio essences changes with a pattern determined by a performer setting steps on the step sequencer. In some embodiments, the step sequencer can be integrated into a musical instrument played by a performer. The tempo of the step sequencer can be set locally and directly by a performer or synchronized with an overall tempo map shared by the performers.

In some embodiments, the performer can generate spatial metadata using a touch-sensitive device or a control user interface, e.g., musical instrument digital interface (MIDI) polyphonic expression controllers 108. The MIDI Polyphonic Expression controller 108 includes a touch-sensitive screen or a control user interface; each point of the touch-sensitive screen or the control surface corresponds to a spatial coordinate in rendering coordinate space. The performer operates on the touch-sensitive screen or the control user interface with hand gestures. The hand gestures can be tracked by a gesture tracking device, e.g., a leap motion controller. The touch-sensitive screen or the control user interface uses MIDI as the protocol for carrying the spatial metadata.

In some embodiments, the performer can generate spatial metadata using an algorithm 112, such as a physics engine. For example, a physics engine can program rules to control generation of spatial metadata, such as basing the generation on arbitrary math functions, time, or other simulated physical properties.

In some embodiments, the performer can set spatial coordinates for some audio essences by manually operating on a software interface. The software interface can show a virtual rendering coordinate space, and the performer can point to (e.g., by a finger) a position on the virtual rendering coordinate space on the software interface, which corresponds to spatial coordinates in the rendering coordinate space.

In some embodiments, the generated spatial metadata 120 can be transported or transferred to spatial metadata modifier 104 or audio renderer 106 via different wireless networks or wired connections (such as Ethernet, I²C, RS-422, radio frequency (RF), Wi-Fi, Bluetooth®, etc.) using various protocols (e.g., Open Sound Control (OSC), MIDI, etc.) to meet the system bandwidth and latency requirements. In an embodiment, the spatial metadata 120 can be transported to spatial metadata modifier 104 for modification, and the modified spatial metadata 122 is then transported to the audio renderer 106. In an embodiment, the spatial metadata can be transported directly to the audio renderer 106 without further modification.

In some embodiments, the spatial metadata generated by one or more performers can be further modified by translating, scaling, rotating, or temporally filtering the spatial metadata. The spatial metadata modification can be performed by a mixing engineer 124 (e.g., a front-of-house (FOH) mixer) or other performers (e.g., performers associated with MIDI control user surface 108, IMU 110, algorithm 112, pedal 114, synthesizer 116), to enable collaborative spatial metadata modifications or to support better overall control of a spatial mix. In some embodiments, the metadata is modified based on an attribute (e.g., spatial coordinates, audio level, audio size, etc.) of the audio essences.

In some embodiments, one or more performers can modify spatial metadata generated by himself/herself or a different performer. The one or more performers can modify spatial metadata using techniques for generating spatial metadata. The metadata modifications can be combined, chained, or even performed in a collaborative way among the performers. In an example, an algorithm, e.g., a physics engine, can be used for metadata modification. The algorithm can prevent spatial interference among audio essences from different performers. For example, two moving balls are used to represent the spatial positions of two performers (spatial positions of audio essences from the two performers). If the two balls collide with each other (spatial positions of audio essences from the two performers become coincident) or a particular ball collides with a wall (a spatial position of an audio essence from a particular performer goes beyond a stage boundary or a zone boundary for this particular performer), the two balls or the particular ball will react according to the rules of the physics engine. For example, the two balls or the particular ball may “bounce” off, which indicates that the audio essences from different performers would not occupy the same spatial coordinates simultaneously, and the algorithm can avoid spatial interference of audio essences. In an embodiment, two or more balls may follow non-Newtonian physics rules. For example, two or more balls may partially or completely overlap with each other, which indicates that the audio essences from different performers would occupy the same spatial coordinates, and the audio essences from different performers mix together.

In an example, two spatial positions can be represented as repelling each other (two spatial positions are very close) or attracting each other (two spatial positions are located within a reasonable distance) as they are being modified in real-time by each of the performers. The algorithm can be used by performers or a mixing engineer to prevent multiple audio essences from destructively interfering with each other in a rendered scene.

In some embodiments, the performer-generated spatial metadata can be used to control individual fine-grained aspects of the various mixes. For example, the spatial metadata is used to only render effect essences, instead of original audio essences. For example, the spatial coordinates are located within a particular zone of an overall spatial presentation. In an example, only spatial coordinates within the particular zone are modified. In another example, the spatial coordinates are modified such that they are constrained to the particular zone.

In some embodiments, the audio essences can be divided into a plurality of frequency bands. The spatial metadata of audio essences in a particular frequency band can be modified independently from spatial metadata of audio essences in other frequency bands. The process of frequency division includes providing potentially unique and independent spatial metadata modifications in different frequency bands.

In some embodiments, the audio essences can also be divided into a plurality of groups. Each group can be sub-rendered separately to generate a plurality of spatial sub-mixes. The spatial metadata of a particular spatial sub-mix can be modified independently from other spatial sub-mixes. The “sub-rendering” can employ sub-renderers earlier in the process than a final renderer used for monitoring and presentation. The “sub-rendering” can reduce the overall number of audio essences for final rendering. For example, a drum set can have multiple microphones (e.g., four microphones) to capture each individual drum, cymbal, etc. The multiple microphones have spatial coordinates relative to each other. A sub-renderer can receive audio essences of the drum set and corresponding spatial metadata, and produce a “spatial sub-mix” of the drum set, including audio essences and associated spatial metadata. Any downstream spatial metadata modification can be performed on the “spatial sub-mix” as a group.

Referring to FIG. 1, in some embodiments, one or more visual audio meters can be used in a live performance system, by performers (e.g., performers associated with MIDI control user surface 108, IMU 110, algorithm 112, pedal 114, synthesizer 116) and/or mixing engineers 124, to have visual monitoring of spatial metadata. The visual monitoring can be in any visual form. For example, a performer can have a visualization of the spatial metadata that this performer is generating or modifying, using a display showing two-dimensional (2D) or three-dimensional (3D) software visualization. The display can be any type of display, e.g., made of a 2D grid of light-emitting diodes (LEDs), liquid-crystal display (LCD), organic light-emitting diode (OLED), or cathode-ray tube (CRT), etc. For example, a performer can have a visualization of the spatial metadata using holography. Likewise, a mixing engineer 124 can also have a similar display integrated into a control console or a performance stage monitoring system. For example, the visualization can include a 3D rendering coordinate space 125 showing positions (spatial metadata) of audio essences. Further, the brightness of balls representing audio essences indicate audio levels of the audio essences. For example, the audio level of the first vocalist audio essence is the highest, and thus the brightness of a ball representing the vocal audio essence is the greatest. In addition, different colors could be used to indicate headroom levels (e.g., green indicates a headroom level >20 dB, yellow indicates a headroom level <20 dB, red indicates a clipping point, etc.).

The audio essences associated with generated spatial metadata can be rendered, by the audio renderer 106, in various immersive sound mixes. For example, the audio essences 118 can be rendered to a local live audience through a speaker array 128. The audio essences can also be rendered to a mixing engineer 124 or one or more performers as a binaural mix, so that the mixing engineer 124 can monitor the audio essences. The audio essences 118 can also be rendered to performers as a binaural mix, so that the performer can monitor the audio essences 118. In an example, the performer or mixing engineer 124 uses an in-ear monitor or headphone 126 for binaural rendering. The audio essences 118 can also be rendered to get recorded by a recording device 130 or broadcasted by a broadcasting device 132. The audio essences 118 can be broadcasted to a remote audience, or recorded and provided to remote audience.

In many embodiments, latency is a factor to be considered for rendering, especially through binaural monitoring/recording and live performance. Low system latency (e.g., less than 10 milliseconds) can ensure that performers hear the results of their spatial metadata generation and/or modification in a timely manner, so as to support their musical performances.

In some embodiments, the audio essences can be rendered to local live audience through binaural recording. In an example, every member of the audience can have personalized binaural rendering. This personalized binaural rendering can apply to, e.g., a “silent disco” type of performance.

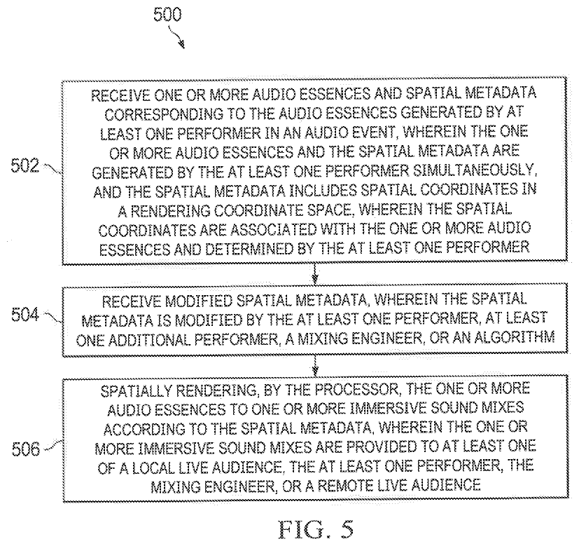

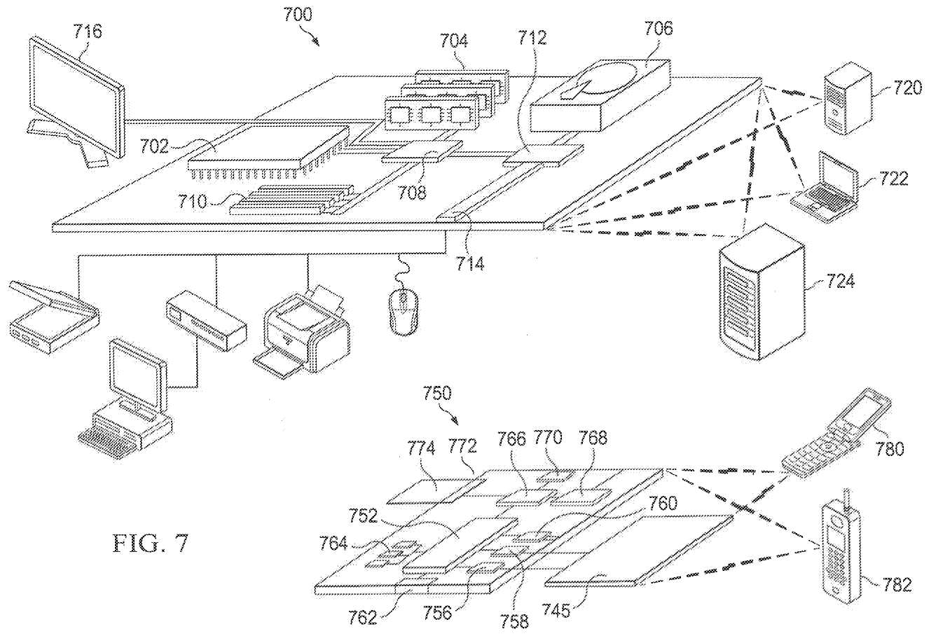

FIG. 5 is a flow chart illustrating an example process 500 of generating and rendering spatial metadata, according to an embodiment. At block 502, the processor (e.g., processors 702 or 752 of FIG. 7) receives audio essences (sounds of piano, guitar, vocal, drum, etc.) and spatial metadata (e.g., spatial coordinates) corresponding to the audio essences. The spatial metadata is generated by performers, such as a pianist, a guitarist, a vocalist, a drummer, etc., in an audio performance. The audio essences and the spatial metadata are generated simultaneously but are sent to an audio renderer (e.g., audio renderer 106 of FIG. 1) separately. The spatial metadata can be generated by performers through IMU, pedal, joystick, electronic musical instrument, a display showing an algorithm or software for generation, etc. The performers can determine the spatial coordinates in a rendering coordinate space to render their own audio essences. The performers can provide physical inputs (e.g., physical motion data, operations, etc.) in a control coordinate space of a controller (e.g., MIDI control user surface 108, IMU 110, algorithm 112, pedal 114, synthesizer 116, etc.) used for generating spatial metadata and the processor can convert the physical inputs in the control coordinate space of a particular controller into spatial coordinates in the rendering coordinate space.

At block 504, the processor receives modified spatial metadata. The spatial metadata can be modified by any performer, a mixing engineer, or an algorithm. In an example, the performer can modify the spatial metadata in an approach similar to that of block 502. In an example, the mixing engineer can use a display showing an algorithm or software for modification.

At block 506, the processor spatially renders the audio essences to immersive sound mixes according to the modified spatial metadata. The audio renderer (e.g., audio renderer 106 of FIG. 1) can render audio essences to a local live audience (using a speaker array 128 of FIG. 1), any performer (using a headphone 126 of FIG. 1), the mixing engineer (using a speaker array 128 or a headphone 126 of FIG. 1), and/or remote audience (using a broadcasting device 132 or a recording device 130 of FIG. 1).

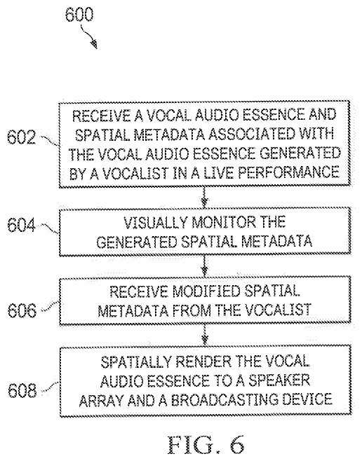

FIG. 6 is a flow chart illustrating another example process 600 of generating and rendering spatial metadata, according to an embodiment. At block 602, the processor (e.g., processors 702 or 752 of FIG. 7) receives a vocal audio essence and spatial metadata associated with the vocal audio essence. The spatial metadata is generated by a vocalist. The vocal audio essence and the spatial metadata are generated simultaneously but are sent to an audio renderer separately. The spatial metadata can be generated through IMU attached to the vocalist. The motion of the vocalist detected by the IMU is converted to the spatial metadata using a linear mapping function.

At block 604, the processor visually monitors the generated spatial metadata in real time. In an example, the processor can show a visualization of the spatial metadata on a display (e.g., display 716, 745 of FIG. 7). Any performer or a mixing engineer can monitor the generated spatial metadata through the visualization. For example, the visualization can show the position of the vocal audio essence on a 2D or 3D rendering coordinate space.

At block 606, the processor receives modified spatial metadata. The spatial metadata can be modified by any performer or a mixing engineer. In an example, the performer can modify the spatial metadata in an approach similar to that of block 502. In an example, the mixing engineer can use a display showing an algorithm or software for modification. For example, the mixing engineer can drag the virtual audio essence on the algorithm or software to a particular virtual position. The particular virtual position corresponds to a spatial coordinate in the rendering coordinate space.

At block 608, the processor spatially renders the vocal audio essence to a speaker array (e.g., speaker array 128 of FIG. 1) for a local live audience and/or a broadcasting device (e.g., broadcasting device 132 of FIG. 1) for a remote audience.

Other operations such as feature based processing may also be handled. Any of the components depicted may be implemented as one or more processes and/or one or more integrated circuits or chips (including ASICs and FPGAs), in hardware, software, or a combination of hardware and software.

In some embodiments, the spatial data generating and rendering system of FIG. 1 and the processes of FIGS. 5 and 6 can be implemented on a computer system, including one or more processors and one or more non-transitory storage media (e.g., non-volatile storage media) operatively coupled to the one or more processors. The computer system may be configured for performing some or all of the methods disclosed herein. In some embodiments, the computer system may implement the techniques described herein using custom logic, an application specific integrated circuit (ASIC), a digital signal processor (DSP), a complex programmable logic device (CPLD), a field programmable gate array (FPGA), firmware and/or other programmable logic, which in combination with the computer system causes or programs computer system to be a special-purpose machine.

FIG. 7 is a block diagram of system 700, 750 (e.g., computing devices) that may be used to implement the systems and methods described in this disclosure, either as a client or as a server or multiple servers. Computing device 700 and 750 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations, e.g., as a server bank, a group of blade servers, or a multi-processor system.

The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer-or machine-readable medium, such as the memory 704, the storage device 706, or memory on processor 702.

The high-speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716, e.g., through a graphics processor or accelerator, and to high-speed expansion ports 710, which may accept various expansion cards (not shown). In the implementation, low-speed controller 712 is coupled to storage device 706 and low-speed expansion port 714. The low-speed expansion port, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 745, a communication interface 766, and a transceiver 768, among other components. The device 750 may also be provided with a storage device, such as a Microdrive or other device, to provide additional storage. Each of the components 750, 752, 764, 745, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 745. The display 745 may be, for example, a TFT LCD display or an OLED display, or other appropriate display technology. The display interface 756 may include appropriate circuitry for driving the display 745 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication, e.g., via a docking procedure, or for wireless communication, e.g., via Bluetooth or other such technologies.

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS receiver module 770 may provide additional wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound, e.g., voice messages, music files, etc., and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back-end component, e.g., as a data server, or that includes a middleware component such as an application server, or that includes a front-end component such as a client computer having a graphical user interface or a Web browser through which a user can interact with an implementation of the systems and techniques described here, or any combination of such back-end, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Memory stores program instructions and data used by the processor of the intrusion detection panel. The memory may be a suitable combination of random access memory and read-only memory, and may host suitable program instructions (e.g. firmware or operating software), and configuration and operating data and may be organized as a file system or otherwise. The program instructions stored in the memory of the panel may store software components allowing network communications and establishment of connections to the data network.

Program instructions stored in the memory, along with configuration data may control overall operation of the system. Server computer systems include one or more processing devices (e.g., microprocessors), a network interface and a memory (all not illustrated). Server computer systems may physically take the form of a rack mounted card and may be in communication with one or more operator terminals (not shown).

All or part of the processes described herein and their various modifications (hereinafter referred to as “the processes”) can be implemented, at least in part, via a computer program product, i.e., a computer program tangibly embodied in one or more tangible, physical hardware storage devices that are computer and/or machine-readable storage devices for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing the processes can be performed by one or more programmable processors executing one or more computer programs to perform the functions of the calibration process. All or part of the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks.

Tangible, physical hardware storage devices that are suitable for embodying computer program instructions and data include all forms of non-volatile storage, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks and volatile computer memory, e.g., RAM such as static and dynamic RAM, as well as erasable memory, e.g., flash memory.

In addition, the logic flows depicted in the figures do not require the particular order shown, or sequential order, to achieve desirable results. In addition, other actions may be provided, or actions may be eliminated, from the described flows, and other components may be added to, or removed from, the described systems. Likewise, actions depicted in the figures may be performed by different entities or consolidated.

Elements of different embodiments described herein may be combined to form other embodiments not specifically set forth above. Elements may be left out of the processes, computer programs, Web pages, etc. described herein without adversely affecting their operation. Furthermore, various separate elements may be combined into one or more individual elements to perform the functions described herein.

Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

Various aspects of the present invention may be appreciated from the following enumerated example embodiments (EEEs):
1. A method comprising:
   receiving, by a processor, one or more audio essences and spatial metadata corresponding to the one or more audio essences generated by at least one performer in an audio performance, wherein the one or more audio essences and the spatial metadata are generated by the at least one performer simultaneously, and the spatial metadata includes spatial coordinates in a rendering coordinate space, wherein the spatial coordinates are associated with the one or more audio essences and determined by the at least one performer; and
   spatially rendering, by the processor, the one or more audio essences to one or more immersive sound mixes according to the spatial metadata, wherein the one or more immersive sound mixes are provided to at least one of a local live audience, the at least one performer, a mixing engineer, or a remote live audience.
2. The method of EEE 1, wherein receiving the one or more audio essences and the spatial metadata corresponding to the one or more audio essences generated by the at least one performer further comprises:
   receiving motion data from an inertial measurement unit associated with a microphone used by the at least one performer, a musical instrument played by the at least one performer, or the at least one performer; and
   converting the motion data in a control coordinate space of the inertial measurement unit to the spatial metadata in the rendering coordinate space using one or more mapping functions.
3. The method of EEE 1 or 2, wherein receiving the one or more audio essences and the spatial metadata corresponding to the one or more audio essences generated by the at least one performer further comprises:
   receiving motion data from a multi-axis pedal used by the at least one performer, wherein the motion data includes changes in azimuth or elevation of the multi-axis pedal; and
   converting the motion data in a control coordinate space of the multi-axis pedal to the spatial metadata in the rendering coordinate space using one or more mapping functions.
4. The method of any one of EEEs 1-3, wherein receiving the one or more audio essences and the spatial metadata corresponding to the one or more audio essences generated by the at least one performer further comprises:
   receiving motion data from a joystick used by the at least one performer; and
   converting the motion data in a control coordinate space of the joystick to the spatial metadata in the rendering coordinate space using one or more mapping functions.
5. The method of any one of EEEs 1-4, wherein receiving the one or more audio essences and the spatial metadata corresponding to the one or more audio essences generated by the at least one performer further comprises:
   receiving motion data from a gesture tracking device or a radio frequency transmitter/receiver proximate to the at least one performer; and
   converting the motion data in a control coordinate space of the gesture tracking device or a radio frequency transmitter/receiver to the spatial metadata in the rendering coordinate space using one or more mapping functions.
6. The method of any one of EEEs 1-5, wherein receiving the one or more audio essences and the spatial metadata corresponding to the one or more audio essences generated by the at least one performer further comprises:
   receiving operations on an electronic musical instrument from the at least one performer, wherein the electronic musical instrument is a synthesizer or a step sequencer; and
   converting the operations in a control coordinate space of the electronic musical instrument to the spatial metadata in the rendering coordinate space using one or more mapping functions.
7. The method of EEE 6, wherein the synthesizer includes one or more low frequency oscillators, and the operations on the electronic musical instrument include controlling the one or more low frequency oscillators to generate the spatial metadata, wherein the one or more low frequency oscillators are configured to generate a plurality of layers of sounds for the one or more audio essences generated by the at least one performer.
8. The method of EEE 7, wherein the one or more audio essences include an original audio essence, an audio essence having sound effects, or a combination of the original audio essence and the audio essence having sound effects, wherein the spatial metadata generated by controlling the one or more low frequency oscillators are used to render the original audio essence, the audio essence having sound effects, or the combination of the original audio essence and the audio essence having sound effects.
9. The method of EEE 6, wherein the synthesizer includes an envelope generator, and the spatial metadata in the rendering coordinate space is generated by operating the synthesizer to control the envelope generator.
10. The method of EEE 6, wherein the synthesizer includes a random voltage generator, and the spatial metadata in the rendering coordinate space is generated by operating the synthesizer to control the random voltage generator.
11. The method of any one of EEEs 1-10, wherein receiving the one or more audio essences and the spatial metadata corresponding to the one or more audio essences generated by the at least one performer further comprises:
   receiving operations on a Musical Instrument Digital Interface (MIDI) Polyphonic Expression controller played by the at least one performer, wherein the MIDI Polyphonic Expression controller includes a touch-sensitive screen or a control user surface, each point of the touch-sensitive screen or the control user surface corresponds to a spatial coordinate in the spatial metadata, wherein the operations include one or more hand gestures operated on the touch-sensitive screen or the control user surface.
12. The method of any one of EEEs 1-11, further comprising:
   receiving modified spatial metadata, wherein the spatial metadata is modified by the at least one performer, at least one additional performer, a mixing engineer, or an algorithm based on an attribute of the one or more audio essences, wherein the modified spatial metadata is configured for translating, scaling, rotating, or temporally filtering the spatial metadata.
13. The method of EEE 12, wherein the spatial metadata is modified based on an attribute of the one or more audio essences.
14. The method of EEE 12, wherein the spatial coordinates are located within a particular zone of an overall spatial presentation.
15. The method of EEE 12, wherein receiving the modified spatial metadata further comprises:
   dividing the one or more audio essences into a plurality of frequency bands; and
   modifying the spatial metadata of an audio essence in a particular frequency band among the plurality of frequency bands.
16. The method of any one of EEEs 1-15, further comprising:
   generating a visualization of the spatial metadata for the at least one performer.
17. The method of any one of EEEs 1-16, wherein spatially rendering the one or more audio essences comprises providing the one or more audio essences to a speaker array for an audience, a binaural audio render for the at least one performer, a broadcasting device, or a recording device.
18. The method of any one of EEEs 1-17, wherein spatially rendering the one or more audio essences comprises:
   dividing the one or more audio essences into a plurality of groups;
   rendering each of the plurality of groups separately to generate a plurality of spatial sub-mixes corresponding to the plurality of groups; and
   modifying the spatial metadata of a particular spatial sub-mix among the plurality of spatial sub-mixes.
19. A system, comprising:
   at least one processor; and
   a memory storing instructions that, when executed by the at least one processor, cause the at least one processor to perform operations according to any one of EEEs 1-18.
20. A non-transitory, computer-readable medium storing instructions that, when executed by at least one processor, cause the at least one processor to perform operations according to any one of EEEs 1-18.

1-20. (canceled)

21. A method comprising:
receiving, by a processor, one or more audio essences generated by at least one performer in an audio performance and spatial metadata corresponding to the one or more audio essences generated by the at least one performer in an audio performance, wherein the one or more audio essences and the spatial metadata are generated by the at least one performer simultaneously, and the spatial metadata includes spatial coordinates in a rendering coordinate space, wherein the spatial coordinates are associated with the one or more audio essences and determined by the at least one performer; and
spatially rendering, by the processor, the one or more audio essences to one or more immersive sound mixes according to the spatial metadata, wherein the one or more immersive sound mixes are provided to at least one of a local live audience, the at least one performer, a mixing engineer, or a remote live audience,
wherein the performer is a musician and/or a vocalist and an audio essence comprises an audio signal or the sound of an audio source; and
wherein receiving the one or more audio essences generated by the at least one performer and the spatial metadata corresponding to the one or more audio essences generated by the at least one performer further comprises:
receiving motion data or operations from a controller associated with or used by the at least one performer when generating an audio essence; and
converting the motion data or operations in a control coordinate space of the controller to spatial metadata corresponding to the audio essence in the rendering coordinate space using one or more mapping functions which map the relationship between motion data or operations from the controller and the rendering coordinate space.

22. The method of claim 21, wherein the controller comprises one of: an inertial measurement unit, a multi-axis pedal, a joystick, a gesture tracking device, a radio frequency transmitter/receiver and an electronic musical instrument.

23. The method of claim 21, further comprising:
receiving motion data from an inertial measurement unit associated with a microphone used by the at least one performer, a musical instrument played by the at least one performer, or the at least one performer; and
converting the motion data in a control coordinate space of the inertial measurement unit to the spatial metadata in the rendering coordinate space using one or more mapping functions.

24. The method of claim 21, further comprising:
receiving motion data from a multi-axis pedal used by the at least one performer, wherein the motion data includes changes in azimuth or elevation of the multi-axis pedal; and
converting the motion data in a control coordinate space of the multi-axis pedal to the spatial metadata in the rendering coordinate space using one or more mapping functions.

25. The method of claim 21, further comprising:
receiving motion data from a joystick used by the at least one performer; and
converting the motion data in a control coordinate space of the joystick to the spatial metadata in the rendering coordinate space using one or more mapping functions.

26. The method of claim 21, further comprising:
receiving motion data from a gesture tracking device or a radio frequency transmitter/receiver proximate to the at least one performer; and
converting the motion data in a control coordinate space of the gesture tracking device or a radio frequency transmitter/receiver to the spatial metadata in the rendering coordinate space using one or more mapping functions.

27. The method of claim 21, further comprising:
receiving operations on an electronic musical instrument from the at least one performer, wherein the electronic musical instrument is a synthesizer or a step sequencer; and
converting the operations in a control coordinate space of the electronic musical instrument to the spatial metadata in the rendering coordinate space using one or more mapping functions.

28. The method of claim 27, wherein the synthesizer includes one or more low frequency oscillators, and the operations on the electronic musical instrument include controlling the one or more low frequency oscillators to generate the spatial metadata, wherein the one or more low frequency oscillators are configured to generate a plurality of layers of sounds for the one or more audio essences generated by the at least one performer.

29. The method of claim 28, wherein the one or more audio essences include an original audio essence, an audio essence having sound effects, or a combination of the original audio essence and the audio essence having sound effects, wherein the spatial metadata generated by controlling the one or more low frequency oscillators are used to render the original audio essence, the audio essence having sound effects, or the combination of the original audio essence and the audio essence having sound effects.

30. The method of claim 27, wherein the synthesizer includes an envelope generator, and the spatial metadata in the rendering coordinate space is generated by operating the synthesizer to control the envelope generator.

31. The method of claim 27, wherein the synthesizer includes a random voltage generator, and the spatial metadata in the rendering coordinate space is generated by operating the synthesizer to control the random voltage generator.

32. The method of claim 21, further comprising:
receiving operations on a Musical Instrument Digital Interface (MIDI) Polyphonic Expression controller played by the at least one performer, wherein the MIDI Polyphonic Expression controller includes a touch-sensitive screen or a control user surface, each point of the touch-sensitive screen or the control user surface corresponds to a spatial coordinate in the spatial metadata, wherein the operations include one or more hand gestures operated on the touch-sensitive screen or the control user surface.

33. The method of claim 21, further comprising:
receiving modified spatial metadata, wherein the spatial metadata is modified by the at least one performer, at least one additional performer, the mixing engineer, or an algorithm based on an attribute of the one or more audio essences, wherein the modified spatial metadata is configured for translating, scaling, rotating, or temporally filtering the spatial metadata.

34. The method of claim 33, wherein the spatial metadata is modified based on an attribute of the one or more audio essences.

35. The method of claim 33, wherein the spatial coordinates are located within a particular zone of an overall spatial presentation.

36. The method of claim 33, wherein receiving the modified spatial metadata further comprises:
dividing the one or more audio essences into a plurality of frequency bands; and
modifying the spatial metadata of an audio essence in a particular frequency band among the plurality of frequency bands.

37. The method of claim 21, further comprising:
generating a visualization of the spatial metadata for the at least one performer.

38. The method of claim 21, wherein spatially rendering the one or more audio essences comprises providing the one or more audio essences to a speaker array for an audience, a binaural audio render for the at least one performer, a broadcasting device, or a recording device.

39. The method of claim 21, wherein spatially rendering the one or more audio essences comprises:
dividing the one or more audio essences into a plurality of groups;
rendering each of the plurality of groups separately to generate a plurality of spatial sub-mixes corresponding to the plurality of groups; and
modifying the spatial metadata of a particular spatial sub-mix among the plurality of spatial sub-mixes.

40. A system, comprising:
at least one processor; and
a memory storing instructions that, when executed by the at least one processor, cause the at least one processor to perform operations according to claim 21.

41. A non-transitory, computer-readable medium storing instructions that, when executed by at least one processor, cause the at least one processor to perform operations according to claim 21.
